(19) United States
(12) Patent Application Publication
(10) Pub. No.: US 2018/0345431 A1
(43) Pub. Date: Dec. 6, 2018

(54) Centering Fixture

(71) Applicant: Robert Thomas Wilson, Fort Smith, AR (US)

(72) Inventor: Robert Thomas Wilson, Fort Smith, AR (US)

(21) Appl. No.: 15/992,335

(22) Filed: May 30, 2018

Related U.S. Application Data
(60) Provisional application No. 62/603,558, filed on Jun. 5, 2017.

(51) Int. Cl. B23Q 3/18; B25B 1/10; B25B 1/02

(52) U.S. Cl. CPC B23Q 3/183; B25B 1/02; B25B 1/10

(57) ABSTRACT

I, Robert Thomas Wilson, being the inventor, have designed this Centering Fixture. This invention is described in enabling detail in the following example which may represent more than one embodiment of the present invention. The Centering Fixture is an accessory attachable to a milling machine vise, it centers similar pieces of material with dimensional variations. Machining processes often begin with cutting a number of pieces from larger stock. These cut pieces will vary due to accuracy limitations of the cutting method used. The Centering Fixture, incorporates two movable extensions that precisely move toward or away from one another at the same rate by rotating a leadscrew having a right-hand thread on one end and a left-hand thread on the other. Using this Centering Fixture material regardless of dimensional variations from one piece to the next are each individually centered aiding in accurate manufacturing. As an example, a cut piece 4.030 inches long would be set up with the 2.015-inch center position of that piece oriented as desired. If the next piece measured 4.120 inches long the Centering Fixture would automatically locate the center of that piece at the 2.060-inch position. This centering function would then repeat with all subsequent like pieces, in this example and in one embodiment. The Centering Fixture is portable allowing easy movement from one machine to the next.

I, Robert Thomas Wilson, have invented the design for a Centering Fixture as shown on Drawings 1/5, 2/5, 3/5, 4/5 and 5/5. This invention is described in enabling detail in the following example which may represent more than one embodiment of the present invention. The Centering Fixture is designed to be mounted onto the jaw of a milling machine vise by tightening four bolts on the fixture. This Centering Fixture precision centers material, in one axis, to be machined, manufactured or processed compensating for tolerance variations in the item to be processed. The leadscrew Part 6, has a right-hand thread on one end and a left-hand thread on the other, when rotated it moves Parts 3 & 4 which in turn carry with them Parts 9,5, 8, and 7 bringing them either toward one another for centering or away from one another to releasing depending on Part 6 rotation.

The Centering Fixture is designed to be adaptable to various size and designs of milling machine vises by adjusting the mounting bolts, Part 15, in this example and in one embodiment.

Commercially available items not drawn with detail however shown on Drawings 1/5 include the following:

Four setscrews Part 13 functioning to adjust two Parts 18 gibs.

One setscrew Part 19 functions to retaining Part 11 the bearing block.

Four Part 10 bolts functioning to secure Part 2 in place.

Two Part 12 flanged bearings positioned in Part 11 bearing block.

Two Part 16 jam-nuts with threads matching threads 6A Part 6.

Two Part 17 jam-nuts with threads matching threads 6C on Part 6.

Two Part 9 bolts attaching Part 5 in place, one threads into Parts 3, and one threads into Part 4.

Four nuts Part 8 hold the adjustable threaded rods 7 in place.

Two Part 7 threaded rods functioning as adjustable pieces to locate the work piece material being centered.

One Part 14, commercial handwheel, crank or knob installed on the end of Part 6 leadscrew for adjusting purposes.

### BRIEF DESCRIPTION OF THE SEVERAL VIEWS OF THE DRAWINGS

Drawings 1/5, FIG. 1, is the front view of the Centering Fixture assembled.

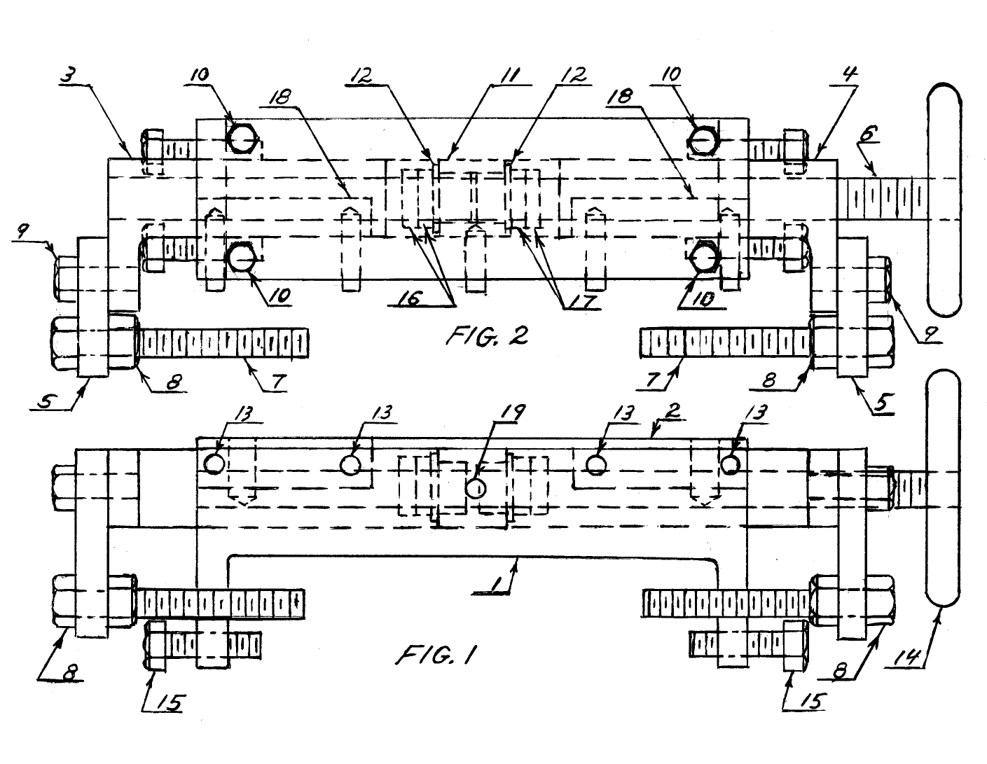

Drawings 1/5, FIG. 2, is the top view of the Centering Fixture assembled.

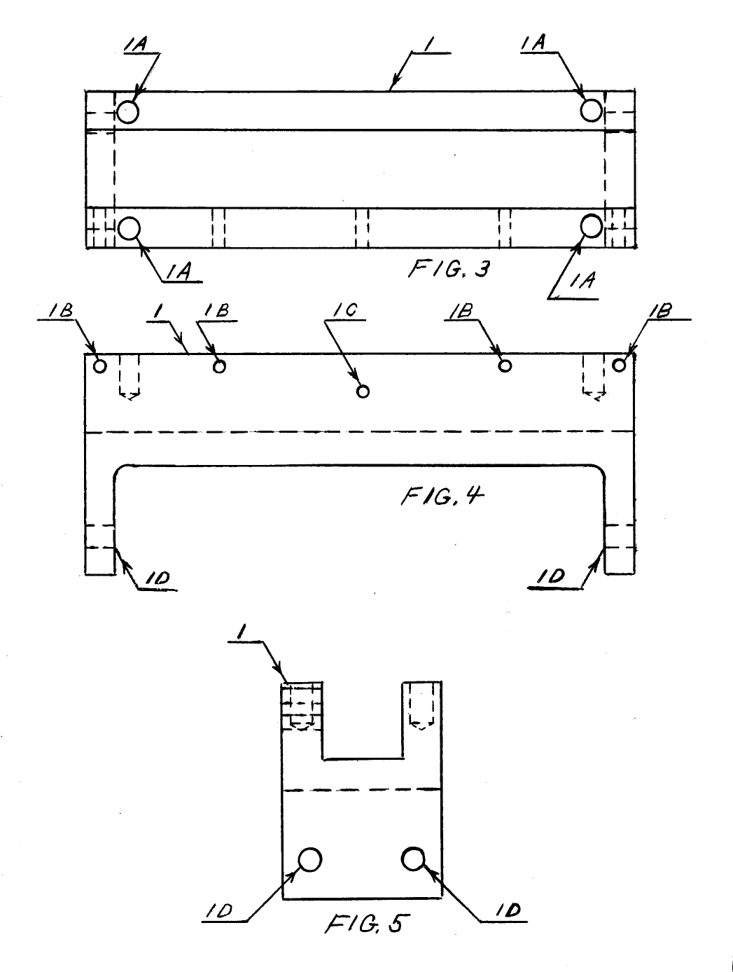

Drawings 2/5 FIG. 3, is the top view of Part 1.

Drawings 2/5 FIG. 4, is the front view of Part 1.

Drawings 2/5 FIG. 5, is the right-side view of Part 1.

Drawings 3/5 FIG. 6, is the top view of Part 2.

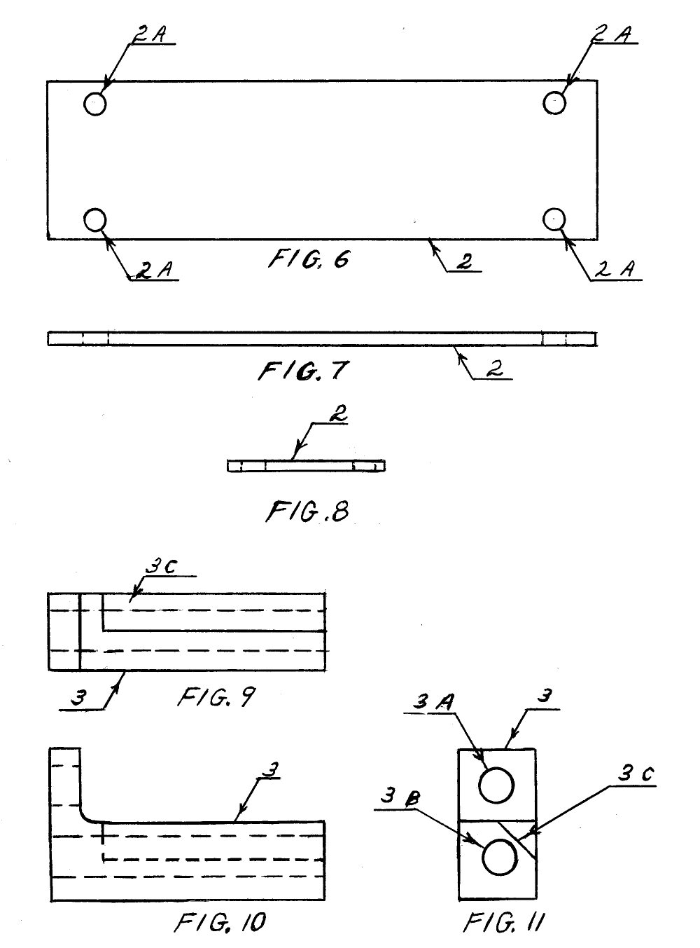

Drawings 3/5 FIG. 7, is the front view of Part 2.

Drawings 3/5 FIG. 8, is the right side vies of Part 2.

Drawings 3/5 FIG. 9, is the top view of Part 3.

Drawings 3/5 FIG. 10, is the front view of Part 3.

Drawings 3/5 FIG. 11, is the right-side view of Part 3.

Drawings 4/5 FIG. 12, is the top view of Part 4.

Drawings 4/5 FIG. 13, is the left side view of Part 4.

Drawings 4/5 FIG. 14, is the front view of Part 4.

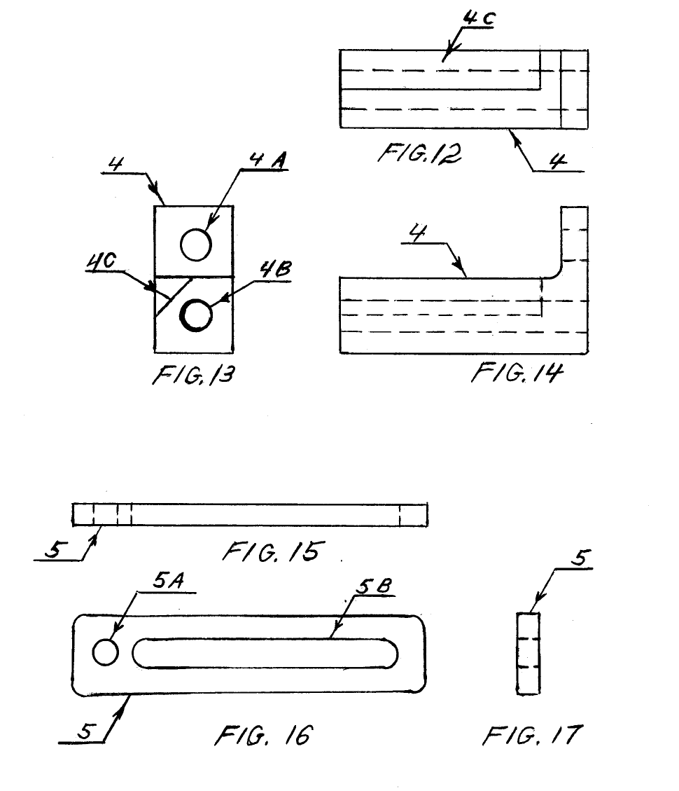

Drawings 4/5 FIG. 15, is the top view of Part 5.

Drawings 4/5 FIG. 16, is the front view of Part 5.

Drawings 4/5 FIG. 17, is the right-side view of Part 5.

Drawings 5/5, FIG. 18 is the top view of Part 6.

Drawings 5/5, FIG. 19 is the right-side view of Part 6.

Drawings 5/5, FIG. 20 is the front view of Part 11.

Drawings 5/5, FIG. 21 is the right-side view of Part 11.

Drawings 5/5, FIG. 22 is the front view of Part 18.

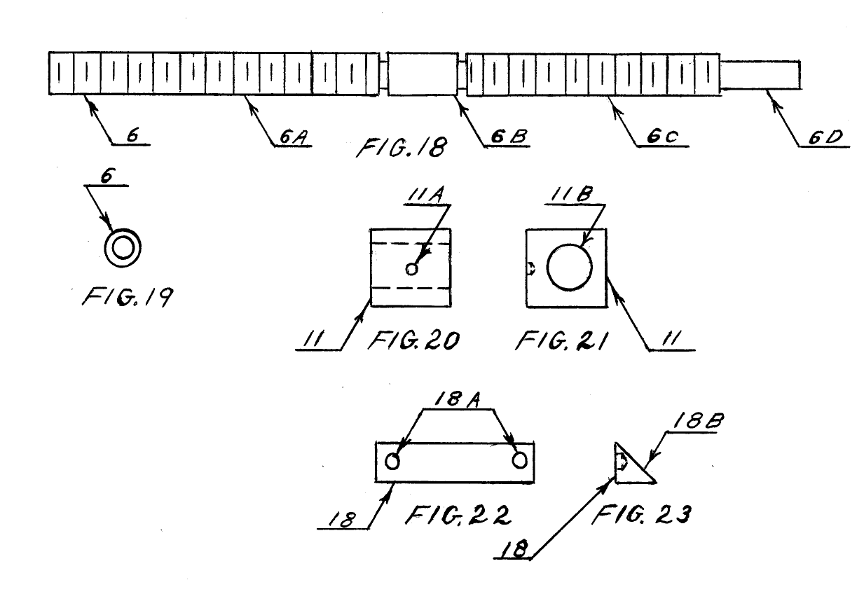

Drawings 5/5, FIG. 23 is the right-side view of Part 18.

### DETAILED DESCRIPTION OF THE SEVERAL VIEWS OF THE DRAWINGS

Drawings 1/5, FIG. 1, is the front view of the Centering Fixture with Parts installed. Part 1 is the base of the Centering Fixture, it is intended to be placed onto a jaw of a milling machine vise. Four bolts, Part 15, when tightened secure the Centering Fixture to a jaw of a milling machine vise. Part 2 is held in place by four bolts Part 10 inserted into threaded holes of Part 1. Part 2 functions to retaining the internal Parts in position. Part 6, the leadscrew has a right-hand thread on one end and a left-hand thread on the other. Part 6 the leadscrew is fitted with an adjusting handwheel, crank or knob Part 14. Part 11 is a bearing block held in place by a setscrew Part 19 and Part 2 the cover plate. Two flanged bearings Part 12 are installed into either end of Part 11 the bearing block. Two jam nuts Parts 16 and too jam nuts Parts 17 securing the flanged bearings in place. Two jam nuts Part 16 have the same thread rotation as 6A on Part 6. Two jam nuts Part 17 have the same thread rotation as 6C on Part 6. When Part 14, the handwheel, crank or knob is rotated it rotates Part 6 the leadscrew. When Part 6 rotates it moves Parts 3 and 4 either closer or farther apart depending on its rotation. Part 3 has threads mating to 6A on Part 6. Part 4 has threads mating to 6C on Part 6. When Part 3 and Part 4 move they in turn each move Parts 9, 5, 8 and 7 to tighten against a workpiece or release the workpiece positioned between the ends of Part 7 depending rotation of Part 14.

Drawings 1/5, FIG. 2, is the top view of the Centering Fixture with Parts installed.

Drawings 2/5 FIG. 3, is the top view of Part 1. Four holes, 1A are threaded to receive bolts Part 10 to hold Part 2 in place.

Drawings 2/5 FIG. 4, is the front view of Part 1. Four 18 threaded holes receive setscrews Parts 13, these screws adjust two Part 18 gibs controlling clearance and removing excess play or slack to the sliding Parts 3 & 4. One threaded hole 1C receives a Part 19 setscrew to secure Part 11, the bearing block in position.

Drawings 2/5 FIG. 5, is the right-side view of Part 1. Four tapped, threaded holes 1D receive four bolts Parts 15 to clamp the Centering Fixture onto a milling machine vise jaw.

Drawings 3/5 FIG. 6, is the top view of Part 2. Four 2A holes allow four Part 10 bolts to pass through Part 2 and thread into part 1 securing Part 2 in place. Part 2 positions and retains Part 3, Part 4, Part 6, Part 11, Parts 12, Parts 16, Parts 17 and Parts 18 in position.

Drawings 3/5 FIG. 7, is the front view of Part 2.

Drawings 3/5 FIG. 8, is the right side vies of Part 2.

Drawings 3/5 FIG. 9, is the top view of Part 3. Part 3 is designed to slide and adjust when the leadscrew part 6 is rotated. Surface 3C contacts a Gib Part 18.

Drawings 3/5 FIG. 10, is the front view of Part 3.

Drawings 3/5 FIG. 11, is the right-side view of Part 3. Surface 3C contacts a gib Part 18. Hole 3B is a tapped with matching threads of 6A Part 6. Hole 3A is tapped to receive bolt Part 9.

Drawings 4/5 FIG. 12, is the top view of Part 4. Part 4 is designed to slide and adjust when the leadscrew Part 6 is rotated. Surface 4C contacts a gib Part 18.

Drawings 4/5 FIG. 13, is the left-side view of Part 4. Hole 4B is tapped through with matching threads 6C Part 6. Hole 4A is tapped to receive bolt Part 9.

Drawings 4/5 FIG. 14, is the front view of Part 4.

Drawings 4/5 FIG. 15, is the top view of Part 5.

Drawings 4/5 FIG. 16, is the front view of Part 5. Two Part 5 pieces are present on this invention, one attaching to Part 3 and one attaching to Part 4. Part 5 has a slot 5B milled through to receive the adjustable bolt Part 7 which may be located as needed.

Drawings 4/5 FIG. 17, is the right-side view of Part 5.

Drawings 5/5, FIG. 18 is the top view of Part 6, a cylindrical leadscrew. External threads 6A and 6C are opposite rotation, one is right hand thread and the other is left hand thread. The right-hand thread may be at either end with the left-hand thread at the opposite end. Therefore, 6A may having a right or left-hand thread affording choice of rotational direction of Part 14 per optional choice. The threads 6C are the same rotation as 4B on Part 4. Threads 6A are the same rotation as 3B on Part 3. Surface 6B is that which will rotate within the flanged bearings Parts 12.

Drawings 5/5, FIG. 19 is the right-side view of Part 6.

Drawings 5/5, FIG. 20 is the front view of Part 11 functioning as a bearing block positioning for two flange bearings Part 12. Blind hole 11A is for the purpose of receiving the end of setscrew Part 19 to retain Part 11 in position.

Drawings 5/5, FIG. 21 is the right-side view of Part 11, through hole 11B is provided for insertion of two Part 12 shoulder bearings.

Drawings 5/5, FIG. 22 is the front view of Part 18 an adjustable gib. Two Part 18 pieces are required for this invention. Two blind holes 18A, on each Part 18 receive the ends of setscrews Part 13 for adjusting out excess play between Part 18 and Part 3 or Part 4.

Drawings 5/5, FIG. 23 is the right-side view of Part 18. Regarding the two Part 18 pieces, surface 18B, Part 18 mates against surface 3C on Part 3 and surface 18B Part 18 mates against surface 4C on Part 4.

1. A fixture mountable onto a milling machine vise jaw, which positions material to be machined facilitating production, said fixture comprising:
1. movable components centering items to be machined in one axis regardless of tolerance variations,
2. said fixture universally mountable to many different sizes and designs of said milling machine vise jaws.
